(19) United States
(12) Patent Application Publication
(10) Pub. No.: US 2003/0172162 A1
(43) Pub. Date: Sep. 11, 2003

(54) Distributed translation network for parallel job execution using registry scheme

(76) Inventors: Roger Twede, Meridian, ID (US); Eugene Aston Roylance, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/094,676

(22) Filed: Mar. 11, 2002

(51) Int. Cl. G06F 15/16

(52) U.S. Cl. 709/226; 709/213

(57) ABSTRACT

Systems and methods for processing of data using registry schemes. In this regard, one such system includes a registry at a first device that is called a responder. This registry contains information corresponding to at least one other device that is called a servicer, which is communicatively coupled to the responder. Upon receiving data related to a requested task, the responder uses the registry to determine whether the data can be more efficiently processed at the responder or at the servicer, and transmits the data to the servicer if the data can be more efficiently processed at the servicer. Other systems and methods, also are provided.

### FIELD OF THE INVENTION

The present invention generally relates to processing data. More specifically, the invention relates to systems and methods for processing data using a registry scheme.

### DESCRIPTION OF THE RELATED ART

Distributed networks include several elements, each one of which may be individually equipped to carry out certain functions depending upon system requirements and/or limitations. Elements of a distributed network, such as the Internet, may include personal computers (PCs), workstations, printers, display devices, and personal digital assistants (PDAs). While a desk-based PC may have enough memory capacity to store several sophisticated applications, such as those required for manipulating text as well as pictures in a multiplicity of formats, a PDA, with its limited memory capacity and computing capabilities, may be limited to only a few such applications. Similarly, a workstation, which in many instances has greater computing abilities than a PC, may utilize certain programs, such as graphics manipulation, which may not be readily operable on PCs. While such limitations may exist in situations where each element is operating in an individual capacity, the power of networking becomes apparent when resources of multiple elements are pooled together and the computing capabilities of the individual elements are utilized in a collective manner.

One application, which may be used to illustrate the limitations of current practices, pertains to obtaining a hardcopy of a document using a printer. Conventional printers are generally perceived to be fairly unintelligent devices that require printer input data to be formatted specifically to the particular hardware inside the printer. A software package typically referred to in the art as a “printer driver” is utilized to translate a job request in a specific software format into what is generally termed a “printer-friendly” format, which the printer then uses to create a hardcopy. This scheme requires installation of a multiplicity of printer drivers for the various devices that constitute a network whenever these devices require printing services.

As an example, a person using a computing device who desires to obtain a hardcopy of one particular document may require a suitable printer driver to be installed on his device to enable interaction with a printer. The number as well as type of such printer drivers installed on his device (e.g., a PDA) may be proportional to the number and type of printers accessed, thereby leading to the possibility of limiting the device's use to certain printers only.

In a second example unrelated to print functionality, a PC user desiring to access a document in one particular format would typically use software that handles this same format to access the document. For example, if a user had to access a document formatted in Corel's WordPerfect™ format, he may access the document using Corel's WordPerfect™ software. However, it may be also possible to use other programs, such as Microsoft Word™, to access this particular document. Use of such alternative software involves the utilization of a software process known as “format conversion” which converts the Corel WordPerfect™ document into a Microsoft Word™ formatted document for access through Microsoft Word™ software.

While a text manipulation software utility such as Microsoft Word™ may be suitable for installation in a multiplicity of computing devices, more complicated software utilities, such as those that may be required for Computer Aided Design (CAD), may not be easily installable in several devices due to limitations in their hardware. Though this hardware limitation may prove to be a handicap to users who desire to use the full suite of services provided by such CAD packages, certain other users who desire to merely view a CAD document may find it beneficial to use a simpler software utility that can carry out this limited viewing function. This simpler software utility may include suitable format conversion software that can accept the document in its original CAD format and convert it into a simpler format suitable for viewing only.

Depending upon the number of such conversion tasks desired, a multitude of conversion software packages may need to be installed on the user's device. While this installation of a multiplicity of software conversion packages may not be an issue for devices having larger storage capacities, it may become an issue for other devices, such as handheld devices, thereby leading to the possibility of limiting the use of those other devices to certain applications only.

Minimizing and/or eliminating the number of conversion software packages, and/or printer drivers, that may be required on a particular device may allow a wider range of applications to be utilized by the device, despite the limitations of the device's hardware. It can therefore be appreciated that it would be desirable to have a translation network that can implement jobs over multiple devices in a distributed network such as the Internet.

### SUMMARY OF THE INVENTION

The present invention provides methods, systems and means for processing data using a registry scheme. In this regard, one embodiment can be broadly summarized by a representative data processing system that includes a registry at a first device labeled as a responder. This registry contains information corresponding to at least one other device labeled as a servicer, which is communicatively coupled to the responder. Upon receiving data related to a requested task, the responder uses the registry to determine whether the data can be more efficiently processed at the responder or at the servicer, and transmits the data to the servicer if the data can be more efficiently processed at the servicer.

Another embodiment can be described as a method for providing at a responder a registry that incorporates information corresponding to at least one servicer. Upon receiving data related to a requested task at the responder, the registry is used to determine whether the data can be more efficiently processed at the responder or at the servicer, and then the data is transmitted to the servicer if the data can be more efficiently processed at the servicer.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic representation of an example system for the distributed translation network.

FIG. 2 is a schematic representation which illustrates a scheme to uniquely identify the individual elements of FIG. 1.

FIG. 3 is a flow chart illustrating a representative process of a task-flow for the translation network.

FIG. 4A is a flow chart that illustrates the providing of a registry and a scheduler to implement a part of the flow chart of FIG. 3.

FIG. 4B is a flow chart illustrating a representative process to fulfill a translation task request.

FIG. 5 is a schematic representation of an embodiment of a responder device shown in FIG. 1.

FIG. 6 is a schematic representation to illustrate print job flows in an example distributed translation network.

FIG. 7 is a second schematic representation to illustrate translation job flows in an example distributed translation network.

### DETAILED DESCRIPTION

The present invention will now be described with particular reference to a scheme that enhances printer capabilities in a distributed network. It should be apparent, however, to persons having ordinary skill in the art that the explanation can be extended to other applications, wherein network facilities can be utilized to implement certain distributed processing functions. A printer, as used today in a networked system, typically uses a spooling function to queue a multiplicity of job requests and carry out certain operations to translate the incoming data files into a printer-friendly format. The spooling function typically operates in a first-in-first-out (FIFO) manner, and multiple print tasks are carried out sequentially in the order they were received at the printer. This serial process creates delays in printing jobs lower in the queue, even if one such job was a simpler task than one ahead of it in terms of the translation to be performed.

One of the elements of the present disclosure incorporates a device referred to as a network appliance (NA). This network appliance may refer to any device that is part of a network and that can communicate with other devices on the network using a multiplicity of addressing schemes and communications means. When the network appliance referred to in this disclosure for example, uses the Internet, it is sometimes referred to as an Internet appliance (IA). Where the network appliance is an imaging device on the Internet, it can be termed an Internet imaging appliance (IIA). The Internet appliance is a web-ready device with networking capabilities, and may be assigned a uniform resource locator (URL) address. Internet appliances communicate with other URL assigned devices in the network and are capable of implementing several functions including, for instance, printing.

When operating as a printer, a network appliance accepts multiple print requests similar to a typical printer. However unlike the typical FIFO queue, the network appliance may utilize the services of several selected devices available on its network to carry out print processing tasks in a parallel fashion. This form of parallel processing allows several tasks to be processed simultaneously, thereby improving the efficiency of the printing process. In this situation, the print job output sequence is determined by the complexity of the task, rather than the arrival time of the task at the printing device as would typically be the case.

The implementation of this operational structure is facilitated by two processes referred to in this disclosure as “registry” and “scheduling.”

“Registry” includes a qualification scheme, whereby a network appliance is loaded with information regarding the capabilities as well as availability of the various elements connected on its network. This information may pertain to services referred to in this document by terms such as “translation,” “conversion,” “rendering,” or “ripping.”

The term “translation,” as used herein, refers to the process by which multiple operations are carried out on a file. A translation may include a format conversion as well as additional functions such as “scaling” which modifies the document into a printer-oriented format.

The term “conversion,” refers to the process whereby a file in one particular format is converted into a file of a different format. An example of such a process may be a file in portable document format (PDF) converted to a file in the Postscript format.

“Ripping” refers to an operation associated with a raster image processor (RIP), and may be appropriate for use in imaging applications.

The registry information can be loaded into the network appliance by several methods. In a relatively static method, information related to various devices connected to the network may be entered by an operator. While one particular device may be capable of carrying out a translation operation on one particular format, a second device may be capable of carrying out a translation operation upon a different second format. Several devices may also be capable of carrying out translation operations on the same one format.

A more dynamic scheme may be implemented in which the network appliance automatically queries other devices connected to its network to determine the capabilities of these devices and obtain data similar to that referred to in the manual entry process. This querying can be of a cyclic nature or can be initiated by other parameters in non-cyclic fashion.

Registry information may be stored in the network appliance in several forms. One such form may be the URL addresses of the various devices on the network. The registry process using URLs allows interaction of the network appliance, for example an Internet appliance, with other Internet accessible appliances. This interaction widens the scope of operations that can be carried out by the network appliance beyond that which can be done on networks that may be either private or smaller in nature than the Internet.

Scheduling involves a qualification scheme that the network appliance uses to determine prioritization parameters upon the various network devices available for access. These parameters permit the network appliance to designate tasks to these devices based upon several criteria such as speed of response and system bandwidth. While speed of response may be used as a primary parameter in selecting one among a multiplicity of devices that are all equipped with functionality to fulfil a particular network appliance request, system bandwidth utilization may also be used as a primary parameter to determine the order of prioritization of this multiplicity of devices. A simple factor to determine speed of response may utilize the extent of loading present on a particular element. Loading may be decided based upon the number of jobs pending at any particular element.

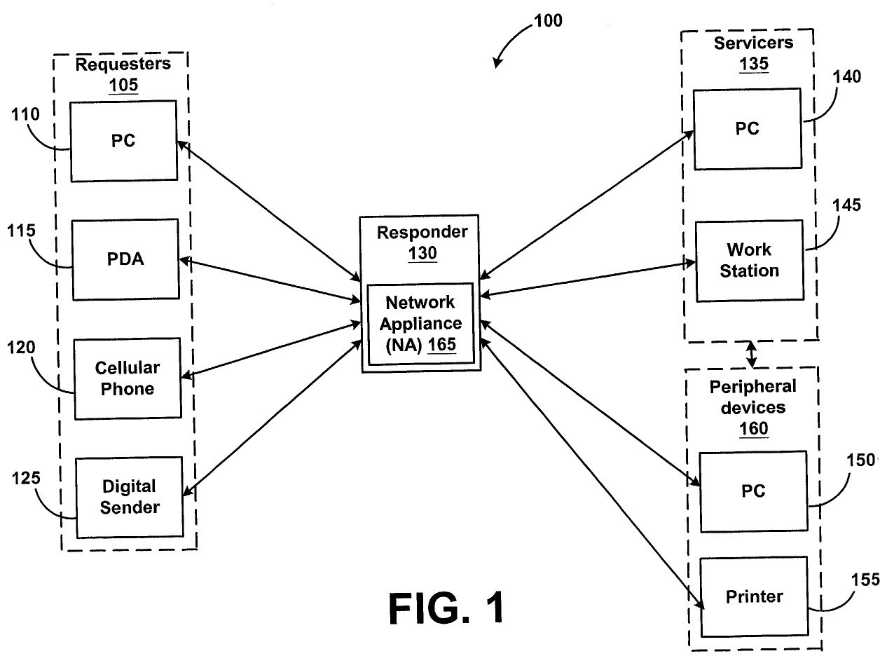

Reference will now be made to FIG. 1, which is a schematic representation of an example system for a distributed translation network 100 that implements parallel or simultaneous job execution using a registry scheme. The translation network 100 can be implemented in hardware, software, firmware, or a combination thereof. In some embodiment(s), the distributed translation network is implemented in software or firmware that is stored in a memory and that is executed by a suitable job execution system. If implemented in hardware, as in an alternative embodiment(s), the translation network can be implemented with any or a combination of the following technologies, which are all well known in the art: a discrete logic circuit(s) having logic gates for implementing logic functions upon data signals, an application specific integrated circuit (ASIC) having appropriate combinatorial logic gates, a programmable gate array(s) (PGA), a field programmable gate array (FPGA), etc.

The distributed translation network 100 includes four general types of components: a requester 105, a responder 130, a servicer 135, and a peripheral device 160.

A requester 105 represents generally any network element that may be configured to communicate electronically with the responder 130 and comprise a distributed translation network. Described in this embodiment are four examples of requesters 105. It should be noted, however, that there are several other requesters that could be used, examples including a notebook computer or a wireless pager.

The first example of a requester 105 is the PC 110. This PC 110 operates as a networked device connected to a wide area network (WAN) such as the Internet, or a local area network (LAN) such as a corporate computer network. The communication link that implements this network connectivity may utilize different electronic formats, such as Ethernet, TCP/IP, SONET, and ATM for transporting data bits, and may use different physical media such as twisted pair copper, fiber, and wireless links.

The second example of a requester 105 is the PDA 115. Applications for PDAs include Internet access which may involve web-surfing, e-mail and data transfer via files, and other documents. Additional applications include computing and storage of utility functions such as calendar information and personal data such as phone numbers and addresses. The PDA 115 can be configured to wirelessly communicate directly, or indirectly with the NA 165 via a secondary network.

Another example of a requester 105 is the cellular phone 120. Recent models of cellular phones have incorporated utilities such as e-mail, text messaging, interactive web browsing and paging services. Cell phones use the cellular wireless network, which interfaces into the plain old telephone system (POTS) network at certain nodes, thereby providing network connectivity between cellular and noncellular devices.

A fourth example of a requester 105 is the digital sender 125. The digital sender 125 is an appliance that can scan and digitize an image or graphic document before transmitting this digital information to another appliance(s) such as the NA 165.

The responder 130 represents generally any network element that may be configured to communicate electronically with the requester 105 and comprise a distributed translation network. In terms of its functionality, the responder 130 receives a request from a requester 105, and provides a service in response to this request. The NA 165, which is one example of a responder, may be a networked appliance that includes software used to implement translation and the registry. Other functions in the NA 165, may include operation as a networked printer device capable of producing hardcopies of documents received by the NA 165 in a variety of formats. If the relevant translation software is not available within the NA 165 itself, the NA 165 is capable of interacting with servicers 135 on the network to utilize the translation services that may be available in any of these servicers 135. The NA 165 may also, in some applications, include an imaging output appliance (not shown) that displays images and graphics on a display screen. Such images may include web pages and photographs or may include graphical images generated using a CAD package such as AutoCAD.

The sevicer 135 represents generally any network element that may be configured to communicate electronically with the responder 130. In terms of its functionality, the servicer 135 receives a request from a responder 130, and provides a service in response to this request. With reference to FIG. 1, the servicer 135 is an appliance that can receive information from the NA 165 and provide various computing services, such as translation, upon the data transmitted to the servicer 135 by the NA 165. The first example of a servicer 135 shown in FIG. 1 is the PC 140. The second example of a servicer 135 is a workstation 145. The workstation 145, provides enhanced computing abilities, in comparison to a PC, for certain types of applications such as graphics and CAD.

Although only two examples of servicers 135 are described, it should be noted that there are several other devices that could be used, such as a notebook computer, a plotter, or a visual display appliance.

The peripheral device 160 represents generally a network element that is or may be configured to communicate with either the servicer 135, or the responder 130. Functionally, a peripheral interacts with other network elements, such as the responder 130, in a limited capacity. For example, the printer 155 may connect into a local port of the NA 165 but may not incorporate a network identifier, such as a URL address. In such a situation, the NA 165 may not include printer 155 into its registry for network translation applications. Peripheral devices may include devices such as a PC 150 and a printer 155.

It should be noted that the communication links between the various components are bi-directional in nature. While certain devices shown in FIG. 1 are referred to as requesters, or as servicers, for ease of explanation, the requesting and servicing functionality of these devices are interchangeable depending upon the nature of the task at any given time, and the bi-directional communication links allow this functional flexibility.

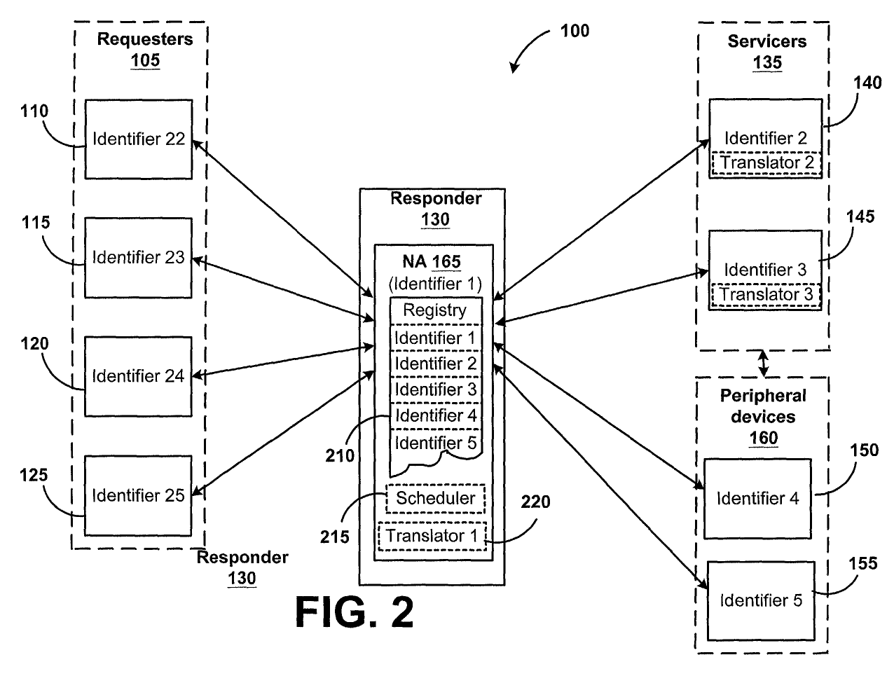

FIG. 2 illustrates a scheme to uniquely identify the individual elements of FIG. 1. In this scheme, each of the devices shown is identifiable by a unique identifier, which may take on the form of a unique address (e.g. a URL address).

The identifiers of all the networked devices are stored as a part of the registry 210 by the NA 165 after it has obtained this information via manual entry through an operator or through automatic means. The identifiers are also used in the registry to categorize the various operational information available from each individual servicer 135. Such operational information may include translator functionality and input/output (I/O) capabilities. The operational information may also be utilized to create a scheduler 215 which may be used to prioritize task flows.

The NA 165 shown in FIG. 2 also includes a translator 220 that is built into the NA 165. This translator may incorporate a limited set of capabilities, and the NA 165 may interact with a servicer 135 to complement this set of translator services, possibly based upon information from the scheduler 215. The translators for the servicers 135 are shown in FIG. 2.

The scheduler 215 may be used to create a prioritization scheme whereby servicers 135 are graded based on several parameters. Such parameters may include, for example, availability factors that may depend upon the existing job load at any particular instant, or characteristics such as operating speed and storage capacity of the individual servicers 135. It must be noted that though the scheduler functionality is shown as a distinct functional block in FIG. 2, the information related to scheduling can be integrated into the registry block shown in FIG. 2 and need not be identified distinctly as such.

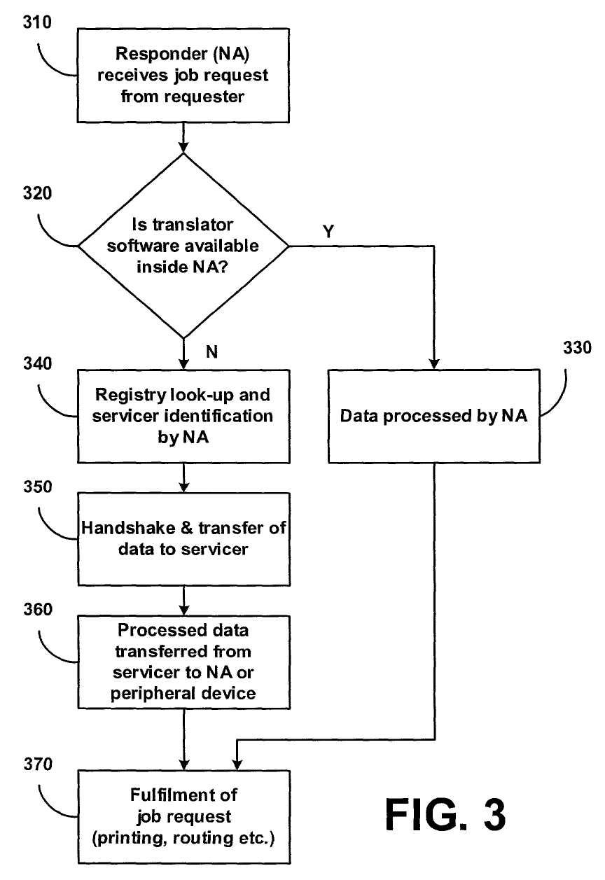

FIG. 3 is a flow chart illustrating a representative process of a task-flow for the translation network. It is to be understood that any process steps or blocks shown in FIG. 3, as well as other flow charts in this document, represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved. Code may also be contained in several devices of the invention, and may not be necessarily confined to any particular device. The explanation below, while possibly implying code residency and functionality in certain devices, does so solely for the purposes of explaining the concept behind the invention, and the description should not be construed as a limiting parameter for the invention's various implementations in other applications.

Beginning with block 310 of FIG. 3 a request is first received by the responder (NA 165) from a requester 105. This request may take the form of, for example, a multi-purpose Internet mail extension (MIME) message requesting a hardcopy output of a document enclosed in or attached to the MIME message. This attached/enclosed document may include a file of digital data in a format that requires translation into a suitable printer friendly software format prior to use by a printer for producing a hardcopy.

Once the request is received, the responder (NA 165) determines if the translation software, in the form of the appropriate printer driver software, is available inside the NA 165 itself, as indicated in decision block 320. If this software is available inside the NA 165, the responder performs a translation process on the document data as shown in block 330 before the task is fulfilled, as indicated in block 370. If the printer driver software is not available within the NA 165, the NA 165 looks up its registry information, in block 340, and identifies an external servicer 135 that contains the translator software. This identification process utilizes the identifier label (for example, an URL) and its associated information relating to translator capabilities. The NA 165 may also utilize the services of the scheduler 215 to help prioritize the task flow.

After identifying a servicer 135 the NA 165 carries out a handshake with the servicer 135, as indicated in block 350. This handshake may, by way of example, take the form of an e-mail request to the servicer 135, and a corresponding e-mail response from the servicer 135 to confirm that servicer 135 is ready to process the translation request. The NA 165 then transmits the data, for instance in the form a secondary MIME request, to this servicer 135. The servicer 135 processes the data and returns the translated data, which is now ready to be printed, back to the NA 165, as indicated in block 360. The NA 165, then fulfils the request and carries out the print job.

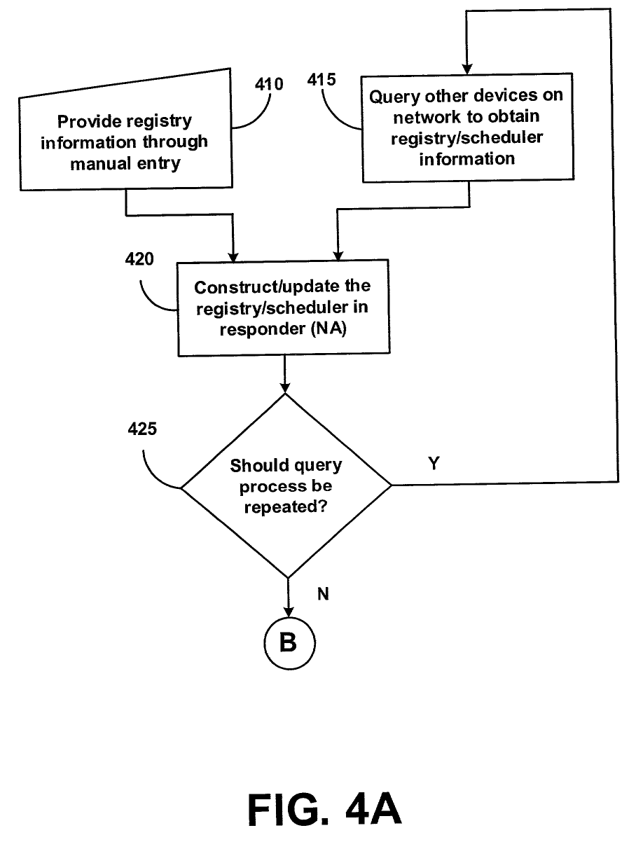

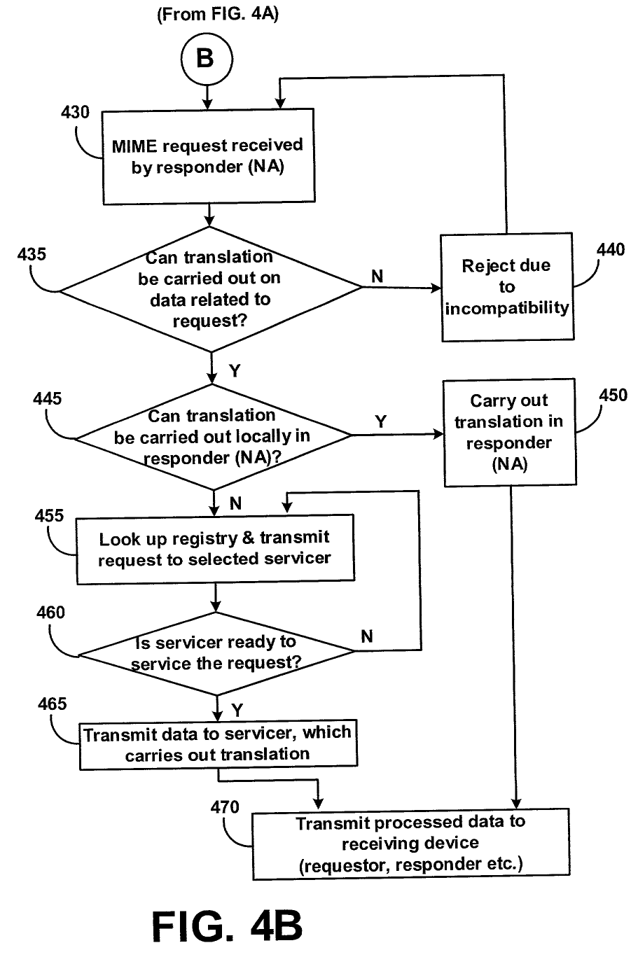

FIG. 4A is a flow chart that illustrates the providing of a registry and a scheduler to implement a part of the flow chart of FIG. 3. This process may be implemented by two alternative methods. In one method indicated in block 410, a manual process is used in which the registry is configured via a web-page available on the NA 165 for such a purpose. In the other method, the registry is configured via bulk e-mails sent to all responder 130 devices on the network that the user wishes to update. Additional possibilities include a management application software that the user will utilize to access and configure the registry information of one or more responders 130 at a time. The operator has the requisite information about other devices on the network, in terms of their URL addresses as well as translation abilities, and uses this information to create the registry within the relevant NA 165. Alternatively, the NA 165 uses an automatic process to construct/update its registry/scheduler. This process includes the querying of various devices that are accessible via the network interconnection (WAN, LAN, etc.) and obtaining the requisite information automatically without intervention of an operator. This is indicated by the interaction of blocks 420, 425 and 415.

Once the registry has been created or updated, NA 165 begins its operation, in the manner referred to by FIG. 4B as an example. A MIME request is first received by the NA 165. Such a request generally takes the form of a translation request accompanied by routing information for the translated data. Upon receiving this request, the NA 165 determines, via decision block 435, if this request can be serviced. This process may partially incorporate a procedure to determine if suitable translator software is available within the NA 165 itself, or if it is resident in one of the other devices. Information on other devices is derived from the registry 210 inside the NA 165. If the service request turns out to be incompatible with the available translator software, the NA 165 responds to the requester 105, as shown in block 440, possibly with an e-mail, indicating a rejection due to incompatibility.

If the translation can be carried out locally by the NA 165 itself, the translation process (block 450) is performed to create the processed data. The processed data is then transmitted to the designated receiving device (block 470). The receiving device that was defined as part of the original request can be a secondary device such as a printer or a display device or it can be the requester 105 device itself.

If the translation has to be carried out by a device other than NA 165, the NA 165 transmits a request (block 455), for example as a MIME message, to an appropriate servicer 135. The NA 165 then waits for acknowledgement and readiness from the servicer 135 device (blocks 460 and 455). Once the acknowledgement signal is received, the NA 165 transmits the data to the servicer 135 device, which carries out the translation task before transmitting the processed data to the destination device. This destination device can be the device that initiated the task or may be the NA 165.

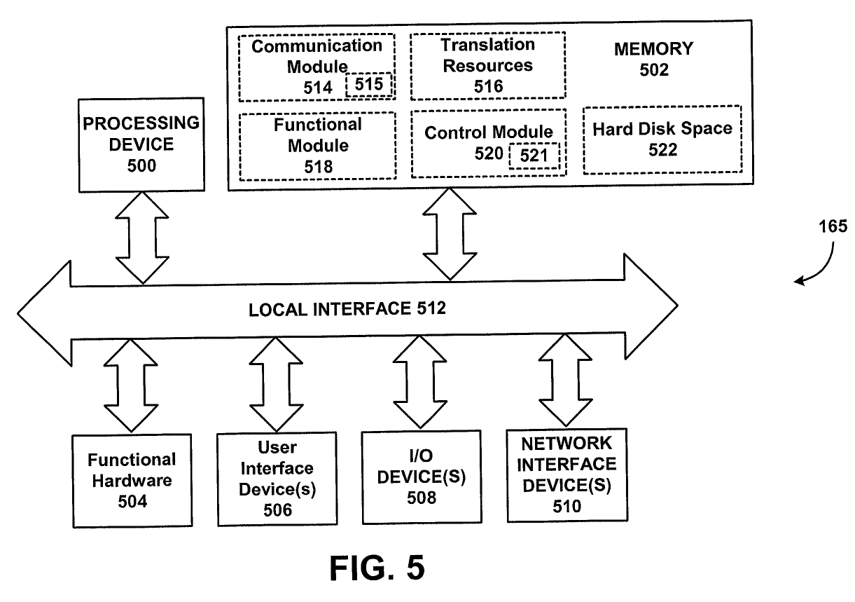

Reference is now made to FIG. 5, which is a schematic representation of the responder device NA 165 of FIG. 1. As indicated in FIG. 5, the NA 165 may incorporate a processing device 500, memory 502, functional hardware 504, one or more user interface devices 506, one or more I/O devices 508, and one or more network interface devices 510. Each of these components is connected to a local interface 512 that, by way of example, incorporates one or more internal buses. The processing device 500 is adapted to execute commands stored in memory 502 and can incorporate a general-purpose processor, a microprocessor, one or more application-specific integrated circuits (ASICs), a plurality of suitably configured digital logic gates, and other well known electrical configurations of discrete elements both individually and in various combinations to coordinate the overall operation of the NA 165.

The functional hardware 504 may provide more functionality to the NA 165. For example, the NA 165 may have printing capabilities, in which case, the functional hardware 504 may have a print engine and other devices to perform the printing. As an additional example, the NA 165 may incorporate a display device. In such a case, the functional hardware 504 may have a display screen to display an image.

The one or more user interface devices 506 typically include interface tools with which the device settings can be changed and through which the user can communicate commands to the NA 165. By way of example, the user interface devices 506 may incorporate one or more function keys and/or buttons with which the operation of the NA 165 can be controlled.

With further reference to FIG. 5, the one or more I/O devices 508 are adapted to facilitate connection of the NA 165 to another device and may therefore include one or more serial, parallel, small computer system interface (SCSI), universal serial bus (USB) and/or a IEEE 1394 (e.g., Firewire™) interface. The network interface device(s) 510 provides a method of interface into a network system to enable communication with other network devices. By way of example, the network interface device 510 may include a device such as a network interface card (NIC) or a modem. Where a modem is provided, it may be a wireless modem, a DSL modem, or a dial-up modem.

The memory 502 includes various software (e.g., firmware) programs including communication module 514, translation resources 516, functional module 518, a control module 520, and hard disk space 522. The various software programs may be operated on the devices located in the NA 165 by the processing device 500.

The communication module 514 utilizes various protocols required to communicate with other devices. The simple mail transfer protocol (SMTP) 515 may be one protocol found in the communication module 514. SMTP is a commonly used protocol to communicate via email as is the post office protocol (POP). The file transfer protocol (FTP), the TCP/IP suite, the hypertext transfer protocol (HTTP) and MIME protocol may all be included in the communication module 514 to facilitate communication with other devices. The communication module 514 may work with the I/O device(s) 508, but more typically will work with the network interface device(s) 510 to facilitate communication with other devices on the network.

The translation resources 516 may include the necessary firmware and/or software to perform various types of data translation, including conversion from one data format to another.

The functional module 518 may contain the firmware and/or software to operate the functional hardware 504 if the NA 165 is so configured.

The control module 520 may include the firmware and/or software that implements the logic to perform the general method of embodiments of the present invention. The control module 520 may be configured to operate with the communication module 514 to receive an e-mail. A software program 521 may be included in the control module 520 that can translate the email and perform the general method. The software program 521 may again work with the communication module 514 to retrieve the data from a specific location. The software program 521 can then call on the translation resources 516 to perform the translation of the data. Once translation is complete, the software program 521 may call on the functional module 518 to, for example, print the translated data. In other embodiments, the software program 521 may work with the communication module 514 to e-mail the translated data back to the requester 105. Integrity checking as well as quality control can be performed in the control module 520.

The hard disk space 522 could be used to store the data before and after translation. Communication logs may also be stored in the hard disk space 522.

Various software and/or firmware programs required to perform the data translation routine have been described herein as well as software and/or firmware required to operate a NA 165 to perform data translation. It will be appreciated that the various software and/or firmware programs can be embodied in any computer-readable medium for use by or in connection with an instruction execution system, apparatus, or transmission device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the information system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable media would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

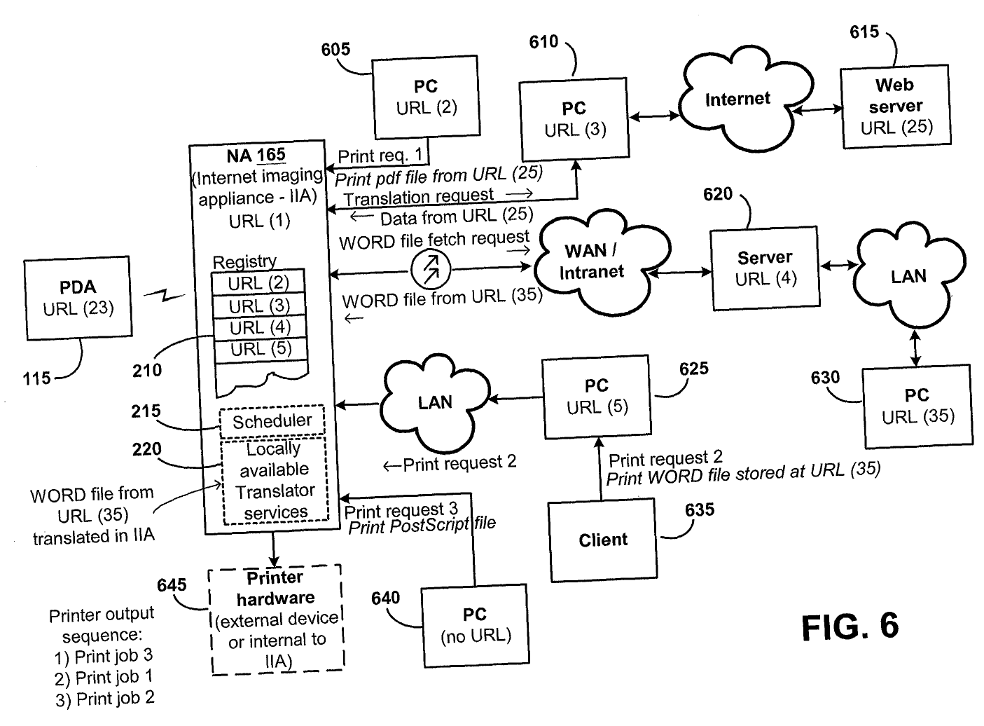

FIG. 6 is a schematic representation to illustrate print job flows in an example distributed translation network. The schematic indicates certain possible scenarios for network interconnectivity, and the various elements that can be connected to form a distributed translation network for parallel job execution using a registry scheme. Although a specific configuration is shown in FIG. 6, this configuration is provided for illustrative purposes only and should not be construed as to limit the present disclosure.

In this embodiment, the NA 165 functions as an Internet imaging device. As shown in FIG. 6, the NA 165 may contain several elements, including the registry 210, the scheduler 215 and the translator 220. The registry 210 may contain information about the translation capabilities of the devices interconnected on this network. In this example, URL addresses are used as identifier information in the registry. Each URL entry may be tied to additional information inside the registry as well as in the scheduler to provide details about the nature of the services available via each device. For example, the entry URL (4) may indicate that the device is a server 620 which has access via its local area network (LAN) to a PC 630 with URL (35). Scheduler information may include the fact that server 620 is reached through a fiber-optic link that is part of a wide area network (WAN) used in a corporate intranet. This intranet connection information in the scheduler may be used to derive information related to speed of response to certain task requests through reference to the available bandwidth on the communication links.

The entry for URL (3) may indicate that the device is a PC 610 directly connected to the NA 165 via a printer cable. Registry information for URL (25) may include the information that the web server 615 can be accessed via PC 610 through the Internet. Again, this Internet connectivity information could be entered into the scheduler to derive information related to speed of response to task requests.

Initiation of a task request may take the form of a MIME message. This MIME message may incorporate several elements. As an example, the MIME message may comprise of the following four elements.

The first element carries the source data in the form of an enclosed, or attached file. Alternatively, the first element may indicate as an identifier label (URL address for example) where the data is available. The second element indicates the desired format for the translated data. The third element includes additional information which is specific to the attached source data file. The fourth element indicates an identifier label (such as a “destination URL”) where the translated data is to be sent. (This identifier label may be the requester's own identifier in the case wherein the requester wishes to obtain the translated data back on his own device.)

The application illustrated in the following example pertains to the implementation of a distributed translation network for parallel job execution of multiple print tasks using a registry scheme. The multiple print tasks generated by several requesters, may appear at the NA 165 in fairly close sequence to one another.

Three different print tasks are used to illustrate operation. Print task 1 is a request from PC 605 to “Print a PDF file stored at URL (25)”. The NA 165 receives the request, possibly as a MIME message.

Upon receiving this request message, the NA 165 looks up its registry, determines that URL (25) is web Server 615 that can be accessed via URL (3) which is a local PC 610. A translation request is sent out to PC 610, possibly in the form of a secondary MIME request. Upon receiving this request, PC 610 accesses the web server 615 and retrieves the PDF document that was requested. After receiving this PDF document, PC 610, converts the PDF document into a print-ready format, and transmits this file to the NA 165. The NA 165 has a printer device 645 resident inside or externally connected to the NA 165, and uses this printer 645 to print out a hardcopy of the requested document.

Print task 2 is a request from client device 635 to its host PC 625. The request may take the form of the command “Print a WORD file stored at URL (35)”. The Internet appliance 165 determines, via its registry, that URL (35) is a PC 630 that can be accessed through server 620, and sends out a request to the server 620 as a “WORD file fetch request”. The server 620 obtains this WORD file from PC 630 and transmits this file in its original format to the NA 165. Upon receiving this WORD file, the NA 165 uses the locally available translator services to carry out a translation from WORD format to a print-ready format. The print-ready formatted document is then sent to the printer 645 for obtaining a hardcopy output.

Print task 3 is a request from PC 640 that has no URL address and consequently no registry information. The NA 165 routes this task directly to the printer 645 with no translation, as the file is already formatted in a print-ready (e.g. PostScript) format.

The three print tasks explained above appear at the NA 165 in the order of print task 1, followed by print task 2, and then print task 3. While these tasks have been described as appearing at the NA 165 in a sequential fashion, it will be appreciated that all three tasks can be executed concurrently by the NA 165 on the various devices referred to above.

As indicated in FIG. 6, the printer 645 does not follow the typical first-in first-out (FIFO) routine. Instead, the printer 645 provides hardcopies based on speed of response. This output may follow the following sequence: print job 3, followed by print job 1, and then print job 2. Print job 3 did not require translation services, and consequently, did not have to traverse an extended communication link. Print job 1 may have appeared ahead of print job 2, in spite of traversing the Internet because the LAN may have been congested at this particular moment. This information can be obtained through the scheduler 215 inside the NA 165.

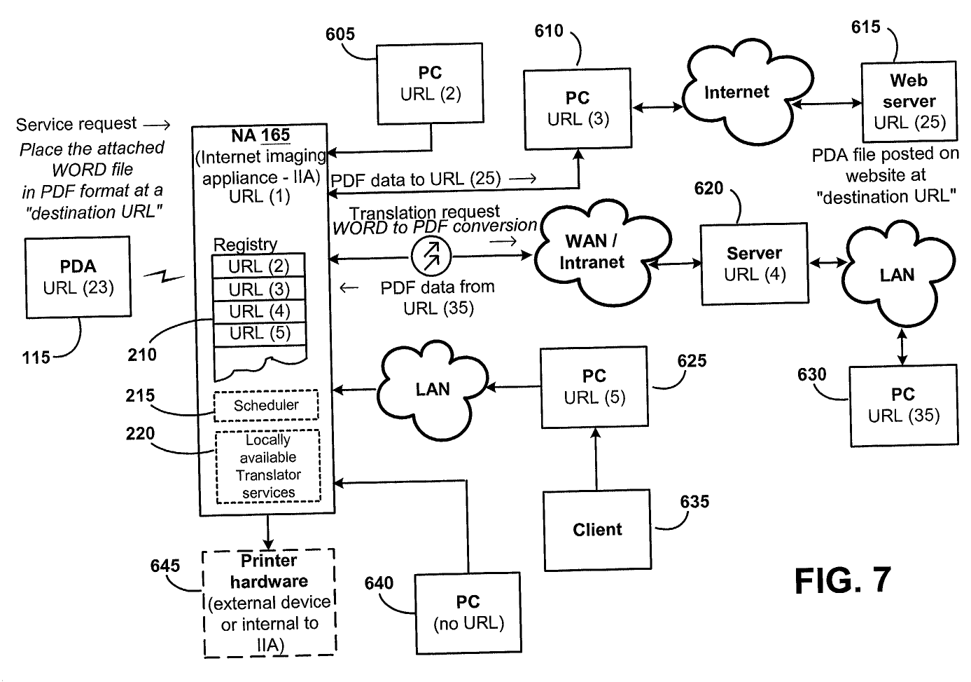

FIG. 7 is a second schematic representation that illustrates translation job flows in an example distributed translation network. In this example, a PDA 115 user intends to update the contents of his personal website. The service request (not a “print request” as in FIG. 6) is transmitted through a wireless medium by the PDA 115. By way of example, this request may require the Internet appliance 165 to “place an attached/enclosed file formatted in WORD, as a PDF-formatted file, at a website which is designated by a destination URL address”.

Upon looking up its registry, the NA 165 may discover that this translation service (WORD to PDF) is not available at the NA 165, but is available via URL (4). A translation request, e.g. a MIME message with the WORD document attached/enclosed is sent by the NA 165 to the server 620. The server 620, then routes this WORD document to PC 630, which carries out the translation into a web-friendly PDF format, and routes this PDF document back to server 620. Upon receiving the document, the server 620 then relays it via a WAN to the NA 165. After looking up its registry information the NA 165 transmits the PDF document via PC 610, to the webserver 615 where it is posted on the PDA 115 user's website at the “destination URL” provided by the original MIME message from the PDA 115 user.

As can be deduced by the examples and illustrations explained in this disclosure, the software which may be needed to carry out several tasks, (examples including “task request,” “registry look-up,” “print file,” and “query devices”) are not necessarily confined to any one particular device in the network. Instead, the software may incorporate several software packages resident in a multiplicity of devices interconnected by a multiplicity of media. For example a PDA 115 user may desire to merely view, and not necessarily edit, a document formatted using AutoCAD software. The hardware limitations of the PDA 115 may prevent the installation of AutoCAD software on his PDA 115, but given the inventive systems and methods described herein, the user may still be able to view the AutoCAD document. This is facilitated by the translation process, in which another device that does contain the AutoCAD software converts the AutoCAD file into a different format that can be then displayed on the PDA 115.

It should be emphasized that the above-described embodiments of the present invention are merely possible examples of implementations and merely set forth for a clear understanding of the principles of the invention. Many variations and modifications may be made to the above-described embodiment of the invention without departing substantially from the spirit and principles of the invention. For example, it will be appreciated by those skilled in the art that the particular format of the information and medium on which it is communicated could be chosen from any means capable of doing so. All such modifications and variations are intended to be included herein within the scope of the present invention and protected by the following claims.

We claim:

1. A method for processing data comprising the steps of:
providing at a responder a registry comprising information corresponding to a servicer;
receiving data related to a requested task at the responder;
using the registry to determine whether the data can be more efficiently processed at the responder or at the servicer; and
transmitting the data to the servicer if the data can be more efficiently processed at the servicer.

2. The method of claim 1, wherein the step of receiving data comprises receiving data from a requester.

3. The method of claim 2, further comprising the step of transmitting data processed by the servicer to the requester.

4. The method of claim 2, further comprising the step of transmitting data processed by the servicer to the responder.

5. The method of claim 2, further comprising the step of transmitting data processed by the servicer to a second servicer.

6. The method of claim 1, further comprising building the registry at the responder using information regarding the capabilities of the servicer.

7. The method of claim 6, wherein the step of building the registry comprises updating the registry at the responder using information provided to the responder by communication means.

8. The method of claim 6, where in the step of building the registry comprises automatically updating the registry at the responder using information regarding the capabilities of the servicer.

9. The method of claim 8, wherein the step of automatically updating the registry of the responder comprises obtaining the information communicatively from the servicer without an update request signal being provided to the responder.

10. The method of claim 8, wherein the step of automatically updating the registry of the responder comprises obtaining the information communicatively from the servicer in response to an update request signal being provided to the responder.

11. The method of claim 1, further comprising the step of transmitting information from the servicer to the responder corresponding to status of data being processed at the servicer.

12. The method of claim 1, wherein the information comprises a uniform resource locator address of the servicer.

13. The method of claim 1, wherein the information comprises a uniform resource locator address associated with capabilities of the servicer.

14. A system for processing data comprising:
a responder having a registry of information corresponding to a servicer, the responder being configured to:
receive data related to a requested task at the responder;
use the registry to determine whether the data can be more efficiently processed at the responder or at the servicer; and
transmit the data to the servicer if the data can be more efficiently processed at the servicer.

15. The system of claim 14, wherein the responder receives data from a requester.

16. The system of claim 15, wherein the servicer is configured to transmit data processed by the servicer to the requester.

17. The system of claim 15, wherein the servicer is configured to transmit data processed by the servicer to the responder.

18. The system of claim 15, wherein the servicer is configured to transmit data processed by the servicer to a second servicer.

19. The system of claim 14, wherein the responder is configured to automatically update the registry using information regarding the capabilities of the servicer.

20. The system of claim 14, wherein the information comprises a uniform resource locator address of the servicer.

21. The system of claim 14, wherein the information comprises a uniform resource locator address associated with capabilities of the servicer.

22. A job execution program stored on a computer-readable medium, the program comprising:
logic configured to provide a registry of information corresponding to a servicer;
logic configured to receive data related to a requested task;
logic configured to use the registry to determine whether the data can be more efficiently processed at a responder or at a servicer; and
logic configured to transmit the data to the servicer if the data can be more efficiently processed at the servicer.

23. The program of claim 22, wherein the logic configured to provide a registry comprises logic configured to receive data from a requester.

24. The program of claim 23, wherein the logic configured at the servicer comprises logic configured to transmit data processed by the servicer to the requester.

25. The program of claim 23, wherein the logic configured at the servicer comprises logic configured to transmit data processed by the servicer to the responder.

26. The program of claim 23, wherein the logic configured at the servicer comprises logic configured to transmit data processed by the servicer to a second servicer.

27. The program of claim 22, further comprising logic configured to build the registry at the responder using information regarding the capabilities of the servicer.

28. The program of claim 22, wherein the logic configured at the responder comprises logic configured to automatically update the registry using information regarding the capabilities of the servicer.
